(19) United States
(12) Patent Application Publication
(10) Pub. No.: US 2005/0099990 A1
(43) Pub. Date: May 12, 2005

(54) Logical connection modification

(76) Inventors: Joanna Uusikartano, Espoo (FI); Aarne Jokinen, Espoo (FI); Giorgi Gulbani, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/478,414

(22) PCT Filed: Dec. 13, 2002
(86) PCT No.: PCT/FI02/01025

(30) Foreign Application Priority Data
Dec. 21, 2001 (FI) 20012561

(51) Int. Cl. H04J 3/24; H04L 12/66

(52) U.S. Cl. 370/349; 370/352

(57) ABSTRACT

The invention relates to a packet-switched part of a mobile communication system, utilising PDP addresses as temporary or permanent network-layer subscriber addresses. With the PDP context a mobile station (MS) is connected to different PDP addresses. A PDP context comprises different data transmission parameters, such as QoS and TFT. The user can modify his PDP context. The invention comprises storing (3-6) the original TFT parameter at least for the duration of the PDP context modification, so that it can be returned (3-9) to the gateway GPRS support node (GGSN) if the radio network does not accept the new QoS profile during the PDP context modification.

### BACKGROUND OF THE INVENTION

The invention relates to a packet-switched part of a core network in 3G (third generation) mobile networks, and particularly to modification of a logical connection set up between a terminal and a network node, e.g. a gateway GPRS support node (GGSN), responsible for the connection in order to transmit data.

The packet-switched part is implemented in 3G mobile networks on the basis of a general packet radio service at least in the beginning. The general packet radio service GPRS was developed to supplement the GSM and to allow the use of packet-switched applications in a mobile network. In GPRS, the logical connection between a mobile station and a gateway GPRS support node is called a PDP context (packet data protocol context). The PDP context is network-level information, which is used to connect a mobile station MS to different PDP addresses, which are either permanent or temporary network-level GPRS subscriber addresses, and to eliminate this connection after use. The PDP context refers to data to be stored in a mobile station MS, a serving GPRS support node SGSN and a GGSN, when a connection has been activated to an external packet data network. If the user desires to modify his PDP context, he sends a PDP context modification request, including new QoS (quality of service) and TFT (traffic flow template) values, to the SGSN. The SGSN thereafter transmits a PDP context updating request to the GGSN. Based on the TFT parameter in the modification request, the GGSN replaces the original TFT value from the PDP context and returns the PDP context updating response to the SGSN. In the next step a radio access bearer RAB procedure implements RAB modification, whereafter the SGSN acknowledges the PDP context modification to the MS.

A problem in the arrangement described above is that with the present standardized methods it is not possible to return the original TFT value to the GGSN, if the radio network controller RNC does not accept the new QoS profile in the RAB modification, but the TFT parameter value of the modification request remains as a TFT value in the GGSN. For instance, the SGSN cannot return the TFT parameter value, because unlike the QoS value, it is transparent to the SGSN.

### BRIEF DESCRIPTION OF THE INVENTION

An objective of the invention is to develop a method and an apparatus implementing the method so as to solve the aforementioned problem. The objective of the invention is obtained by a method, a system and network nodes, which are characterized by what is disclosed in the independent claims. The preferred embodiments of the invention are disclosed in the dependent claims.

The invention is based on detecting and solving the problem such that the preceding TFT parameter value-is stored at least for-the duration of the modification of the logical connection so that it can replace the value updated in the GGSN, if necessary.

In a preferred embodiment of the invention, in the PDP context modification the original TFT parameter is added to an Update PDP context response message transmitted by the GGSN to the SGSN. An advantage of the embodiment is that the SGSN is informed of the preceding TFT value and it can store it temporarily. It can thus return the original TFT value to the GGSN if the RNC does not accept the new QoS profile in the RAB modification.

### BRIEF DESCRIPTION OF THE FIGURES

The invention will be described in more detail in connection with the preferred embodiments and with reference to the accompanying drawings, in which

FIG. 1 illustrates the UMTS/GPRS network architecture,

FIGS. 2 and 3 illustrate signalling according to a first preferred embodiment of the invention.

### DETAILED DESCRIPTION OF THE INVENTION

The preferred embodiments of the invention will be described below implemented in a 3G WCDMA (wideband code division multiple access) mobile communication system, such as the UMTS (universal mobile telecommunications system). However, the invention is not restricted to these embodiments, but it can be applied in any mobile communication system implementing a GPRS-type packet radio that is capable of transmitting packet data. Other examples of such systems are IMT-2000, IS-41, GSM (Global System for Mobile communications) or other similar mobile communication systems, such as the PCS (Personal Communication System) or the DCS 1800 (Digital Cellular System for 1800 MHz). Specifications of mobile systems in general and of the IMT-2000 and the UMTS in particular develop rapidly. Such development can require additional changes to be made to the invention. Therefore, all the words and expressions should be interpreted as broadly as possible and they are only intended to illustrate and not to restrict the invention. What is essential for the invention is the function itself and not the network element or the device in which the function is implemented.

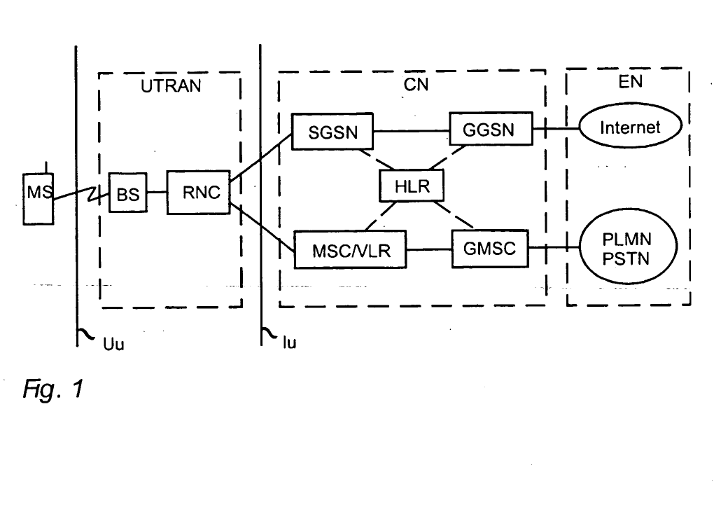

FIG. 1 shows a simplified version of the UMTS architecture, which illustrates only the components that are essential to the invention, even though those skilled in the art naturally know that a general mobile communication system also comprises other functions and structures, which do not have to be described in more detail herein. The main parts of the UMTS are a core network CN, a UMTS radio access network UTRAN (Universal Terrestrial Radio Access Network) and a mobile station MS, which is also referred to as user equipment UE. The interface between the CN and the UTRAN is called an Iu interface and the air interface between the UTRAN and the mobile station MS is called a Uu interface. The Uu interface is a radio interface.

The UTRAN is a theoretical concept for the 3G radio network and it identifies the network part between the Iu and Uu interfaces, comprising radio network controllers RNC and base stations BS (node B).

A radio network controller RNC is a network node, which controls UTRAN radio resources. It corresponds logically to a GSM base station controller BSC. In FIG. 1, the RNC is connected to two CN nodes: the SGSN and a mobile switching centre MSC, which comprises an integrated visitor location register VLR. In some network topologies it may become possible in the future that one RNC is connected to one or more than two core network CN nodes, which can be of the same or different types, for example one RNC can be connected to several SGSNs.

The core network CN can be connected to external networks EN, which can be either circuit-switched CS networks, such as a public land mobile network PLMN, a public switched telephone network PSTN, and an integrated services digital network ISDN, or packet-switched PS networks, such as the Internet and X.25. The core network CN comprises a home location register HLR, a mobile switching centre/visitor location register MSCNLR, a gateway MSC GMSC, an SGSN and a GGSN. The core network described herein is based on a 3G UMTS network. Other types of core networks, for example the IS-41, can comprise other network elements.

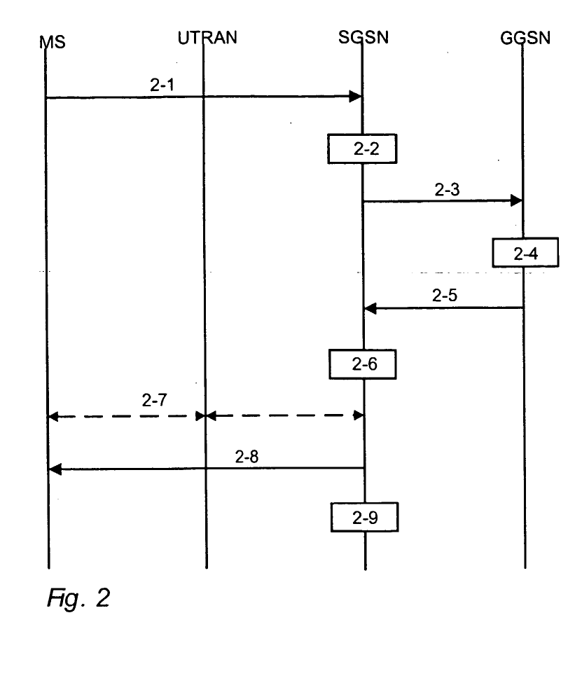

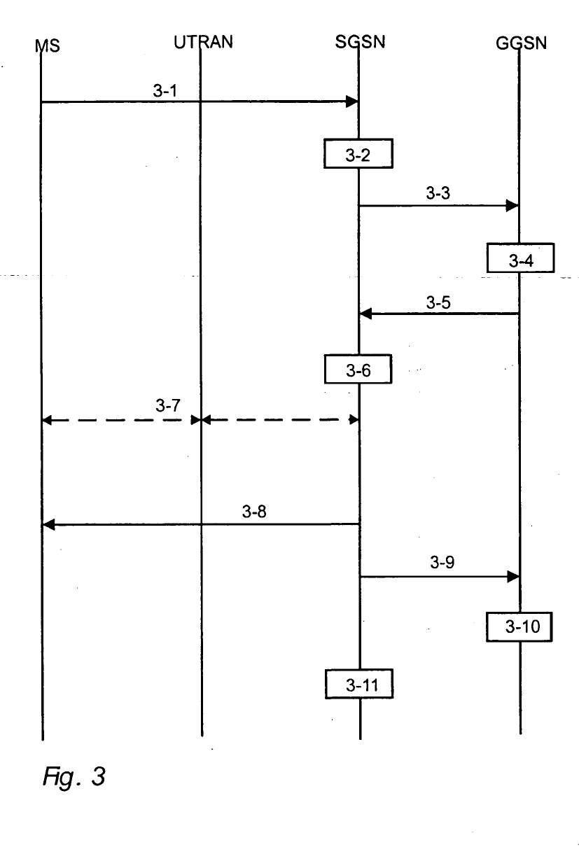

The packet-switched part of 3G networks will utilize the GPRS system. The GPRS system, which employs 3G radio access (such as the UMTS) or 2G radio access (such as the GSM), comprises GPRS nodes, i.e. a serving GPRS support node (SGSN) and a gateway GPRS support node (GGSN). The main functions of the SGSN include detecting new GPRS mobile stations MS in its service area, handling registration processes of new MSs with the GPRS registers, transmitting/receiving data packets to/from the GPRS mobile station MS, and maintaining a register of locations of MSs within the service area. The operation of an SGSN according to a first embodiment of the invention will be described below in connection with FIGS. 2 and 3.

The main function of the GGSN is interaction with an external data network. The GGSN connects the operator to the systems outside the GPRS network, such as GPRS systems of other operators, to data networks, such as the IP network or the X.25 network, and to the service centres. The GGSN contains the PDP addresses and routing information, or SGSN addresses, of GPRS subscribers. Based on the TFT parameter, the GGSN filters the packets to different PDP contexts. The operation of a GGSN according to the first embodiment of the invention will be described below in connection with FIGS. 2 and 3.

In the area of the same PLMN, the SGSN and the GGSN are interconnected by an internal operator network, which can be implemented, for example, by means of an IP network.

Subscriber data are stored in the GPRS register HLR, which stores the interdependence between the MS identity, such as MS-ISDN or IMSI (international mobile subscriber identity) and the PDP address.

The mobile station MS can be a simplified terminal intended only for speech, or it can be a terminal for multiple services operating as a service platform and supporting the loading and execution of different service-related functions. The mobile station MS comprises actual mobile equipment ME and a removably associated identification card USIM (universal subscriber identity module), which is also called a subscriber identity module. In this connection, a mobile station MS (i.e. user equipment) generally refers to an entity of the actual terminal and the subscriber identity module. The subscriber identity module USIM is a smart card containing the subscriber identity, executing authentication algorithms and storing authentication and encryption keys and subscriber data needed at the mobile station. The mobile equipment ME is a radio terminal used for radio communication between the mobile station MS and the UTRAN via the Uu interface. The mobile equipment can be any equipment or a combination of several different equipment capable of communicating in the mobile communication system.

The RAB (radio access bearer) service is set up between the mobile station MS and the core network and it contains a service provided by the access layer to the non-access layer for forwarding user data. Different RABs are used according to the subscription, service, desired QoS or the like. The core network controls the set-up, modification and disassembly of RAB over the UTRAN. Set-up and modification of the RAB are functions that the core network initiates and the UTRAN implements.

In order to transmit and receive GPRS data, the mobile station MS has to activate at least one PDP address it wants to use. The PDP refers to a protocol transmitting data as packets. This activation makes the mobile station MS known in the corresponding GGSN, and interaction with external data networks can commence. The PDP context defines different data transmission parameters, such as the PDP type (e.g. X.25 or IP), PDP address, quality of service QoS, and network service access point identifier NSAPI.

A mobile station associated with the GPRS system can commence the PDP context activation at any time by transmitting an Activate PDP context request message to the SGSN. After the SGSN has received the message, it transmits a Create PDP context request message to the GGSN, which sets up the PDP context and transmits it to the SGSN. The SGSN transmits the PDP connection to the mobile station MS in an Activate PDP context response message, and a virtual connection or link is set up between the mobile station MS and the GGSN. As a result, the SGSN forwards all the data packets from the mobile station MS to the GGSN, which in turn forwards all the data packets received from an external network and addressed to the mobile station MS to the SGSN. The PDP context is stored in the mobile station MS, the SGSN and the GGSN. When the mobile station MS moves to the area of a new SGSN, the new SGSN requests for the PDP context from the old SGSN, or if the transfer takes place in an active state, where the signalling connection is open between the UTRAN and the SGSN, the old SGSN immediately gives the PDP contexts to the new SGSN at the beginning of the transfer phase. The GPRS contract comprises one or more PDP addresses. The PDP context refers not only to the GPRS system but to any logical connection which is set up between the terminal and the network element responsible for the connection in order to transmit packet-switched data. Each PDP address is described by one or more PDP contexts in the mobile station MS, the SGSN and the GGSN. Each PDP context can be provided with a traffic flow template parameter (TFT parameter). Based on the TFT parameter, packets are filtered to different PDP contexts of the PDP address. The TFT parameter refers to filtering bases, i.e. to any parameter or group of parameters, on the basis of which a PDP context is selected for a data packet to be transmitted. A PDP address should have at most one PDP context with no associated TFT.

After the activation the PDP context modification occurs according to certain principles and in uniform steps. The modification procedures modify parameters defined for the PDP context during activation. The parameters of each PDP context are preferably defined specifically for this context. A modification request can be initiated by a mobile station MS, an SGSN or a GGSN, and the modification can be commenced at any time.

FIGS. 2 and 3 illustrate signalling according to the first preferred embodiment of the invention when the user wants to modify TFT and/or QoS parameters. FIG. 2 shows signalling of successful modification and FIG. 3 shows signalling of unsuccessful modification. It is assumed in the signalling charts according to the first preferred embodiment shown in FIGS. 2 and 3 that a PDP address has one PDP context. It is evident for those skilled in the art what the signalling chart looks like when a PDP address has more than one PDP context.

With reference to FIG. 2, the user transmits a Modify PDP context request to the SGSN in message 2-1. This message includes at least fields: QoS requested and TFT. “QoS requested” indicates the QoS profile the user desires, and TFT indicates the TFT that is to be modified or added to or removed from the PDP context.

In item 2-2, the SGSN can restrict the desired QoS profile depending on the SGSN capacity, transient load and the QoS profile of the subscriber. The SGSN then transmits an Update PDP context request in message 2-3 to the GGSN. This message includes at least fields: QoS negotiated and TFT. “QoS negotiated” is the value of the QoS profile possibly restricted by the SGSN.

In item 24, the GGSN can further restrict the TFT and QoS negotiated values depending on the GGSN capacity, transient load and the subscriber QoS profile. The GGSN stores the QoS negotiated value and the TFT value it has possibly restricted. Based on the TFT value, the GGSN can modify or remove the TFT value from the PDP context, instead of storing the value. The GGSN thereafter returns the Update PDP context response to the SGSN in message 2-5. This message includes at least a QoS negotiated field. According to the present invention, the original TFT parameter of the preceding PDP context is added as a new field to the Update PDP context response message 2-5.

The SGSN separates the original TFT value from message 2-5 and stores it temporarily in item 2-6. The RAB location procedure thereafter implements successful RAB modification by message 2-7. In a Modify PDP context accept message 2-8, the SGSN acknowledges the PDP context modification to the mobile station MS. In item 2-9, the SGSN eliminates the original TFT parameter from its memory.

The signalling in FIG. 3 propagates to the RAB modification to message 3-7 similarly as the signalling shown in FIG. 2, and it will not be repeated in connection with FIG. 3.

FIG. 3 shows a situation where the radio network controller RNC does not accept the new QoS profile in the RAB modification 3-7. The SGSN then transmits a Modify PDP context reject message 3-8 to the mobile station MS to reject the RAB modification. The SGSN transmits an Update PDP context request message 3-9, which includes at least the original TFT value, to the GGSN. In item 3-10, the GGSN replaces the TFT parameter in its memory with the original TFT parameter. In item 3-11, the SGSN eliminates the original TFT parameter from its memory. In the network, this results in the same situation as before the modification procedure.

The signalling messages and items shown in FIGS. 2 and 3 are not in an absolute chronological order and they can be executed in a different order from the given one. Other signalling messages can be transmitted and/or other functions can be carried out between the messages and/or items. The signalling messages are only examples and can include only some of the aforementioned information. The messages can also include some other information. The names of the messages can also differ from the aforementioned ones. It is not essential for the invention in which signalling messages the information is transmitted, but it is also possible to use other messages than those described above.

According to an embodiment of the invention, the SGSN does not eliminate the original TFT parameter from its memory.

According to another embodiment of the invention, the original TFT parameter is stored in the GGSN. In this embodiment, if the-QoS profile is not accepted in the RAB modification, the SGSN sends the GGSN information that the GGSN should use the original TFT parameter.

According to yet another embodiment of the invention, the original TFT parameter is stored in the mobile station. In this embodiment, if the QoS profile is not accepted in the RAB modification, the SGSN requests the mobile station for the original TFT parameter and forwards it to the GGSN.

According to yet another embodiment of the invention, the original TFT parameter is stored in the mobile station. In this embodiment, if the QoS profile is not accepted in the RAB modification, after obtaining a RAB modification reject message, the mobile station automatically transmits the original TFT parameter to the SGSN, which forwards it to the GGSN.

The terms “packet data protocol” (PDP) and “PDP context” used herein should be understood to refer generally to a state in a mobile station and to at least one network element or functionality producing via the mobile network a data packet transfer path or tunnel with a specified set of parameters. The term “node” used herein should be understood to refer generally to a network element or functionality that processes data packets transmitted via the PDP channel.

In addition to prior art devices, the system, system nodes or mobile stations implementing the operation according to the invention comprise means for storing an original TFT parameter as described above. The existing network nodes and mobile stations comprise processors and memory, which can be used in the functions according to the invention. All the changes needed to implement the invention can be carried out by means of software routines that can be added or updated and/or routines contained in application specific integrated circuits (ASIC) and/or programmable circuits, such as an electrically programmable logic device EPLD or a field programmable gate array FPGA.

It is evident to those skilled in the art that as the technology develops, the basic idea of the invention can be implemented in various manners. The invention and the embodiments thereof are thus not restricted to the examples described above, but they may vary within the scope of the appended claims.

1. A method of returning a filtering basis preceding the modification in a mobile communication system in the modification of a logical connection set up between a mobile station and a network node responsible for the connection, the method comprising
storing in the mobile station or in the mobile network the filtering basis preceding the modification at least for the duration of the modification of the logical connection, and
returning the filtering basis preceding the modification as a filtering basis for the network node responsible for the connection in response to unsuccessful modification.

2. A method as claimed in claim 1, comprising
transmitting the filtering basis preceding the modification from the network node responsible for the connection to a network node serving the mobile station,
storing the filtering basis preceding the modification in the network node serving the mobile station, and
transmitting the filtering basis preceding the modification from the network node serving the mobile station to the network node responsible for the connection in response to rejection of the modification of the logical connection.

3. A method as claimed in claim 2, comprising transmitting the filtering basis preceding the modification to the network node serving the mobile station in a modification acknowledgement message.

4. A method as claimed in claim 1, comprising
storing the filtering basis preceding the modification in the mobile station, and
transmitting the filtering basis preceding the modification from the mobile station to the network node responsible for the connection as a response to rejection of the modification of the logical connection.

5. A method as claimed in claim 1, comprising
storing the filtering basis preceding the modification in the network node responsible for the connection, and
transmitting the information on the rejection of the modification of the logical connection also to the network node responsible for the connection.

6. A mobile communication system comprising
at least one mobile station for packet-switched data transmission,
a network node serving the mobile station for transmitting packet-switched data to/from the mobile station, and
a network node responsible for the connection for transmitting packet-switched data between the mobile station and other networks,
in which system it is possible to set up a logical connection between the mobile station and the network node responsible for the connection, the logical connection having a valid filtering basis stored in at least the network node responsible for the connection and which logical connection is modifiable, wherein
the network node serving the mobile station is also configured to receive a filtering basis preceding the modification from the network node responsible for the connection, to store the filtering basis preceding the modification at least for the duration of the modification of the logical connection, and to transmit the filtering basis preceding the modification to the network node responsible for the connection in response to rejection of the modification of the logical connection in a radio part of the mobile communication system, and
the network node responsible for the connection is also configured to transmit the filtering basis preceding the modification to the network node serving the mobile station in response to the modification of the connection in the network node responsible for the connection, to receive the filtering basis preceding the modification in a message indicating the rejection of the modification, and to store the filtering basis preceding the modification as a valid filtering basis in response to reception of the message indicating the rejection of the modification.

7. A mobile communication system comprising
at least one mobile station for packet-switched data transmission,
a network node serving the mobile station configured to transmit packet-switched data to/from the mobile station, and
a network node responsible for the connection for transmitting packet-switched data between the mobile station and other networks,
in which system it is possible to set up a logical connection between the mobile station and the network node responsible for the connection, the logical connection having a valid filtering basis stored in at least the network node responsible for the connection and which logical connection is modifiable, wherein
the mobile station is also configured to store the filtering basis preceding the modification and the valid filtering basis at least for the duration of the modification of the logical connection, to use the filtering basis preceding the modification as the valid filtering basis in response to rejection of the modification, and to transmit the filtering basis preceding the modification to the network node serving the mobile station, if the modification is rejected,
the network node serving the mobile station is also configured to transmit the filtering basis preceding the modification to the network node responsible for the connection, and
the network node responsible for the connection is also configured to receive the filtering basis preceding the modification in a message indicating the rejection of the modification, and to store the filtering basis preceding the modification as the valid filtering basis in response to reception of the message indicating the rejection of the modification.

8. A system as claimed in claim 7, wherein the network node serving the mobile station is also configured to request for the filtering basis preceding the modification from the mobile station in response to the rejection of the modification.

9. A system as claimed in claim 7, wherein the mobile communication system is based on a general packet radio service, the logical connection is a PDP context, the filtering basis is a TFT parameter, and the network node responsible for the connection is a gateway GPRS support node.

10. A network node serving a mobile station in a mobile communication system, where it is possible to set up at least one logical connection between the mobile station and a network node responsible for the connection of the mobile station in the mobile communication system, the logical connection having at least a filtering basis as its parameter and which logical connection is modifiable, and which network node serving the mobile station comprises
a first routine configured to receive a first message, which indicates how the mobile station wants to modify the parameters included in the logical connection,
a second routine configured to transmit a second message to the network node responsible for the connection, the second message including the parameters of the first message, updated by the network node serving the mobile station,
wherein it also comprises
a third routine configured to receive a third message from the network node responsible for the connection, the third message including the parameters of the second message, updated by the network node responsible for the connection, and a filtering basis preceding the modification and intended for the logical connection in the network node responsible for the connection, and
a fourth routine configured to distinguish the filtering basis preceding the modification from the third message, and to store said filtering basis preceding the modification in a memory at least for the duration of the modification of the logical connection.

11. A network node as claimed in claim 10, wherein it further comprises a fifth routine configured to transmit the filtering basis preceding the modification to the network node responsible for the connection in response to rejection of the modification of the logical connection.

12. A network node as claimed in claim 10, wherein it is a serving packet radio support node (SGSN) of a network based on a general packet radio service.

13. A network node responsible for the connection of a mobile station in a mobile communication system, where it is possible to set up at least one logical connection between the mobile station and the network node responsible for the connection, the logical connection having at least a filtering basis as its parameter and which logical connection is modifiable, wherein the network node responsible for the connection of the mobile station further comprises a first routine configured to transmit a filtering basis preceding the modification to a network node serving the mobile station in response to the modification of the logical connection.

14. A network node as claimed in claim 13 responsible for the connection of a mobile station, wherein the first routine is configured to add the filtering basis preceding the modification to a modification acknowledgement message.

15. A network node as claimed in claim 13, wherein it comprises a second routine configured to receive a message indicating rejection of the modification, the message including the filtering basis preceding the modification, to distinguish the filtering basis preceding the modification from the message, and to store it in the memory to replace the filtering basis in its memory with the filtering basis preceding the modification, the message including the original PDP context parameters.

16. A network node as claimed in claim 13, wherein it is a gateway GPRS support node of a network based on a general packet radio service.

17. A system as claimed in claim 6, wherein the mobile communication system is based on a general packet radio service, the logical connection is a PDP context, the filtering basis is a TFT parameter, and the network node responsible for the connection is a gateway GPRS support node.
